(19) United States
(12) Patent Application Publication
(10) Pub. No.: US 2008/0279054 A1
(43) Pub. Date: Nov. 13, 2008

(54) Device for digitalizing, recording and playing audio signals of a record

(76) Inventors: Shen-Chi Liu, Tainan City (TW); Chin-Chen Ho, Rende Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/797,919

(22) Filed: May 9, 2007

(51) Int. Cl. H04B 1/20

(52) U.S. Cl. 369/4

(57) ABSTRACT

A device includes a turntable, a pickup, and a digital audio signal processor with a built-in compression/uncompression chip; in use, as soon as the pickup reads analogous audio signals of a vinyl record, the analogous audio signals will be converted into digital ones by means of an analog-to-digital converter, which are next sent to the digital audio signal processor, and compressed by means of the built-in chip of the digital audio signal processor, and stored in a large-capacity storage medium; afterwards, the digital audio signals are uncompressed by means of the chip, and converted into analogous ones by means of a digital-to-analog converter, which are next sent out through a low-pass wave filter.

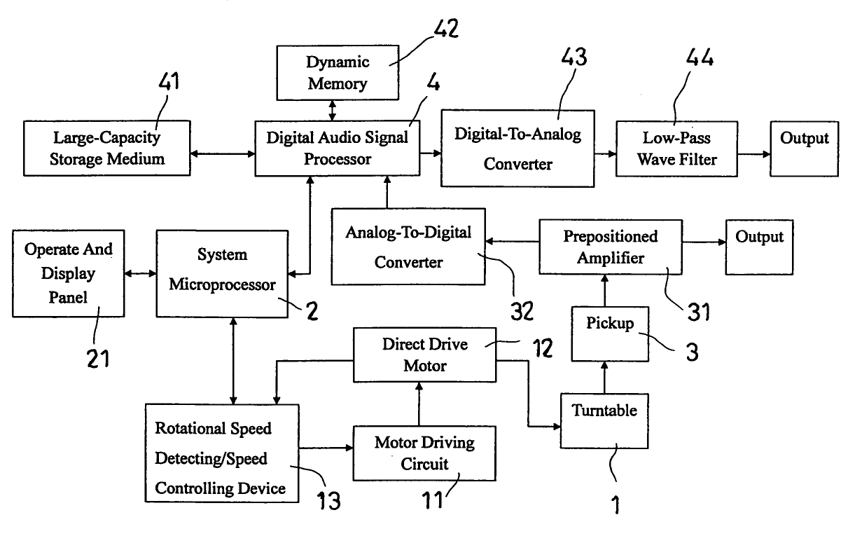

### BACKGROUND OF THE INVENTION

1. Field of the Invention

The present invention relates to a device for digitalizing, recording and playing audio signals of a record, more particularly one, which when playing a vinyl record, can convert analogous audio signals of the record into digital ones, and store the digital audio signals in a large-capacity storage medium in order to send out the audio signals afterwards.

2. Brief Description of the Prior Art

In order to help increase hot and exciting atmosphere in a concert or a party such as is held in a PUB or a dancing hall, the DJ usually makes the music sent out with scratch sound effects by means of manually moving a conventional vinyl record positioned on the turntable at changing speeds and in alternate directions. As soon as the DJ stops moving the vinyl record with his hands, the record player will resume playing the record in the normal way. However, a single vinyl record has very limited capacity to store music in, and a DJ has to prepare a lot of vinyl records in every event, and the records are likely to cause the DJ inconvenience due to the large size and heavy weight. Moreover, conventional vinyl records are prone to be damaged when they are manually moved on the turntable. Currently, CD/MP3 records are gradually taking the place of conventional vinyl records because they have larger capacity for storing music, and are smaller in size and more convenient to use than vinyl records. Therefore, various more advanced audio signal players are developed for playing CD/MP3 records, which can be easily operated by DJ.

Such CD/MP3 audio signal players are easier to operate and use. However, they have to read audio signals stored in CD/MP3 records with laser heads, whose average service life is between one and two thousand hours, not long enough. Consequently, there will be frequent change of laser heads, and the expenditure of money to use such CD/MP3 audio signal players very high. In addition, there are still many DJ who prefer performing with conventional vinyl records, which are difficult to preserve. And, there are many amateurs of vinyl records. Therefore, it is worth developing a more convenient vinyl record player.

### SUMMARY OF THE INVENTION

It is a main object of the present invention to provide an improvement on an audio signal playing device to overcome the above problems. An audio signal playing device according to an embodiment of the present invention includes a turntable, a pickup, an analog-to-digital converter, a digital-to-analog converter, and a digital audio signal processor with a built-in compression/uncompression chip; in use, as soon as the pickup reads analogous audio signals of a vinyl record, the analogous audio signals will be converted into digital ones by means of the analog-to-digital converter, which are next sent to the digital audio signal processor, and compressed by means of the chip of the digital audio signal processor, and stored in a large-capacity storage medium. Afterwards, the digital audio signals are uncompressed by means of the chip, and converted into analogous ones by means of the digital-to-analog converter, which are next sent out through a low-pass wave filter. Thus, the audio signals from the vinyl record will be more easily preserved. In addition, the audio signal playing device will have longer service life, and will be more practical owing to the use of a large-capacity storage medium, which has relatively long service life.

### BRIEF DESCRIPTION OF THE DRAWINGS

The present invention will be better understood by referring to the accompanying drawings, wherein:

The FIGURE is a block diagram of the structure of the present invention.

### DETAILED DESCRIPTION OF THE PREFERRED EMBODIMENTS

Shown in the Fig. is a structural block diagram of a preferred embodiment of a device for digitalizing, recording and playing audio signals of a record, which includes:

a turntable 1, the turntable 1 is rotated by means of a direct drive motor 12, which is controlled by means of a motor driving circuit 11; a feed-back signal of the rotational speed of the direct drive motor 12 is provided to a rotational speed detecting/speed controlling device 13 so that the rotational speed detecting/speed controlling device 13 makes the direct drive motor 12 rotate the turntable 1 at a stable speed through the motor driving circuit 11;

a system microprocessor 2 connected to the rotational speed detecting/speed controlling device 13; an operate and display panel 21 is connected to the system microprocessor 2 in order for rotation of the turntable 1 to be controlled through the system microprocessor 2 by means of using the operate and display panel 21;

a pickup 3 arranged on the turntable 1, a prepositioned amplifier 31 is connected to the pickup 3, and a analog-to-digital converter 32 is connected to the prepositioned amplifier 31; and

a digital audio signal processor 4 connected to both the system microprocessor 2 and the analog-to-digital converter 32; the digital audio signal processor 4 has a built-in compression/uncompression chip; the digital audio signal processor 4 is connected to a large-capacity storage medium 41 such as an USB portable memory disk, USB hard disk, and memory card; the digital audio signal processor 4 is further connected to dynamic memories 42, and a digital-to-analog converter 43, which is connected to a low-pass wave filter 44.

In use, after a vinyl record is positioned on the turntable 1, the present device is operated and set by means of using the operate and display panel 21 in order for the system microprocessor 2 to make the direct drive motor 12 rotate the turntable 1 at a stable speed through the rotational speed detecting/speed controlling device 13 and the motor driving circuit 11; thus, the pickup 3 reads analogous audio signals of the vinyl record on the turntable 1, which is next sent out through the prepositioned amplifier 31; the rotational speed of the turntable 1 will be shown on the operate and display panel 21 at the same time.

Furthermore, as soon as the pickup 3 reads analogous audio signals of the vinyl record on the turntable 1, the analogous audio signals will be converted into digital audio signals by means of the analog-to-digital converter 32. Next, the digital audio signals are sent to the digital audio signal processor 4, and compressed by means of the built-in compression/uncompression chip of the digital audio signal processor 4, and stored in the large-capacity storage medium 41 to be used in the future.

In order to send out the digital audio signals, they are first uncompressed by means of the built-in compression/uncompression chip of the digital audio signal processor 4, and temporarily stored in the dynamic memories 42. Next, the digital audio signals are converted into analogous audio signals by means of the digital-to-analog converter 43, which are sent out through the low-pass wave filter 44; at the same time, information about the audio signals will be shown on the operate and display panel 21 for the operator.

From the above description, it can be seen that the audio signal playing device of the present invention has an advantage over the prior art: As soon as the pickup reads analogous audio signals of the vinyl record on the turntable, the analogous audio signals will be converted into digital audio signals by means of the analog-to-digital converter, which are next sent to the digital audio signal processor, and compressed by means of the compression/uncompression chip of the digital audio signal processor, and stored in the large-capacity storage medium; afterwards, the digital audio signals can be uncompressed with the compression/uncompression chip, and converted into analogous audio signals by means of the digital-to-analog converter, which will be sent out through the low-pass wave filter; thus, the audio signals from the vinyl record will be more easily preserved. In addition, the audio signal playing device will have longer service life, and will be more practical owing to the use of the large-capacity storage medium, which has relatively long service life.

What is claimed is:

1. A device for digitalizing, recording and playing audio signals of a record, comprising
a turntable for a record,
a analog-to-digital converter connected to a pickup on the turntable, and
a digital audio signal processor connected to the analog-to-digital converter, the digital audio signal processor having a built-in compression/uncompression chip;
the digital audio signal processor being connected to a large-capacity storage medium;
the digital audio signal processor being connected to a plurality of dynamic memories;
the digital audio signal processor being connected to a digital-to-analog converter, which is connected to a low-pass wave filter.

2. The device for digitalizing, recording and playing audio signals of a record, as recited in claim 1, wherein the large-capacity storage medium is an USB portable memory disk.

3. The device for digitalizing, recording and playing audio signals of a record, as recited in claim 1, wherein the large-capacity storage medium is an USB hard disk.

4. The device for digitalizing, recording and playing audio signals of a record, as recited in claim 1, wherein the large-capacity storage medium is a memory card.
